(19) United States
(12) Patent Application Publication
(10) Pub. No.: US 2011/0220148 A1
(43) Pub. Date: Sep. 15, 2011

(54) Method for performing preventative maintenance in a substrate processing system

(75) Inventors: Steven P. CONSIGLIO, Albany, NY (US); Cory WAJDA, Sand Lake, NY (US); Robert D. CLARK, Schenectady, NY (US)

(73) Assignee: TOKYO ELECTRON LIMITED, Tokyo (JP)

(21) Appl. No.: 12/723,498

(22) Filed: Mar. 12, 2010

(51) Int. Cl. B08B 7/04

(52) U.S. Cl. 134/18; 134/32

(57) ABSTRACT

A method for performing preventative maintenance in a substrate processing system is described. The method includes diagnosing a level of contamination in a substrate processing system, scheduling a wet clean process when necessary, and scheduling a dry clean process when necessary. The dry clean process may include an ozone cleaning process.

### BACKGROUND OF THE INVENTION

1. Field of Invention

The invention relates to preventative maintenance in a substrate processing system configured for treating a substrate. More particularly, the invention relates to the mitigation of contamination in a substrate processing system.

2. Description of Related Art

High dielectric constant (high-k) materials are desirable for use as gate dielectrics and capacitor dielectrics in future generations of electronic devices. The first high-k materials used as a gate and/or capacitor dielectric were tantalum oxide and aluminum oxide materials. Currently, hafnium-based dielectrics are expected to enter production as gate dielectrics, thereby replacing the current silicon oxide and silicon oxynitride materials.

During the deposition of such materials, metal-containing residue accumulates on the interior surfaces of the vapor deposition system within which the film is being deposited. As residue agglomerates, it may be released from the interior surfaces of the vapor deposition system and, thus, cause particle generation. The released particles may migrate to other surfaces, such as an upper surface of a substrate holder, wherein the released particles may come into contact with the backside of a production substrate. Particle contamination, including metal-containing particles, is a serious problem for semiconductor manufacturing. Therefore, significant effort is taken to maintain the cleanliness of the vapor deposition system interior.

### SUMMARY OF THE INVENTION

The invention relates to preventative maintenance in a substrate processing. More particularly, the invention relates to the mitigation of contamination in a substrate processing system.

According to one embodiment, a method of performing preventative maintenance in a substrate processing system is described. The method comprises diagnosing a level of contamination in a substrate processing system, comparing the level of contamination to a first threshold, scheduling a wet clean process if the level of contamination exceeds the first threshold, comparing the level of contamination to a second threshold, and scheduling a dry clean process if the level of contamination exceeds the second threshold and is less than the first threshold. Furthermore, the dry clean process is performed by introducing a flow of ozone produced by an ozone generator coupled to the substrate processing system and gettering material in the substrate processing system.

According to another embodiment, a dry cleaning method for removing particle contamination from a deposition system is described. The method comprises disposing a substrate on an upper surface of a substrate holder in a deposition system, introducing a flow of ozone from an ozone generator into the deposition system, and gettering material in the deposition system using the substrate.

### BRIEF DESCRIPTION OF THE DRAWINGS

In the accompanying drawings:

FIGS. 1A through 1C illustrate a schematic representation of a substrate processing system according to an embodiment;

FIG. 2 illustrates a schematic representation of a substrate processing system according to another embodiment;

FIG. 3 provides a flow chart for performing preventative maintenance in a substrate processing system according to another embodiment; and

FIG. 4 provides a flow chart for performing a dry cleaning method to remove particle contamination from a substrate processing system according to yet another embodiment.

### DETAILED DESCRIPTION OF SEVERAL EMBODIMENTS

In the following description, for purposes of explanation and not limitation, specific details are set forth, such as a particular geometry of a substrate processing system and descriptions of various components and processes used therein. However, it should be understood that the invention may be practiced in other embodiments that depart from these specific details.

Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

“Substrate” as used herein generically refers to the object being processed in accordance with the invention. The substrate may include any material portion or structure of a device, particularly a semiconductor or other electronics device, and may, for example, be a base substrate structure, such as a semiconductor wafer or a layer on or overlying a base substrate structure such as a thin film. Thus, substrate is not intended to be limited to any particular base structure, underlying layer or overlying layer, patterned or un-patterned, but rather, is contemplated to include any such layer or base structure, and any combination of layers and/or base structures. The description below may reference particular types of substrates, but this is for illustrative purposes only and not limitation.

As described above, substrate processing systems and the processes executed therein suffer from residue accumulation on the interior surfaces of the substrate processing system within which the substrate is being treated, e.g., a film is being deposited, a film is being etched, a film is being treated or modified, etc. This residue may cause particle generation and subsequent device contamination due to migration of these particles to the backside surface of substrates used in the production of electronic devices.

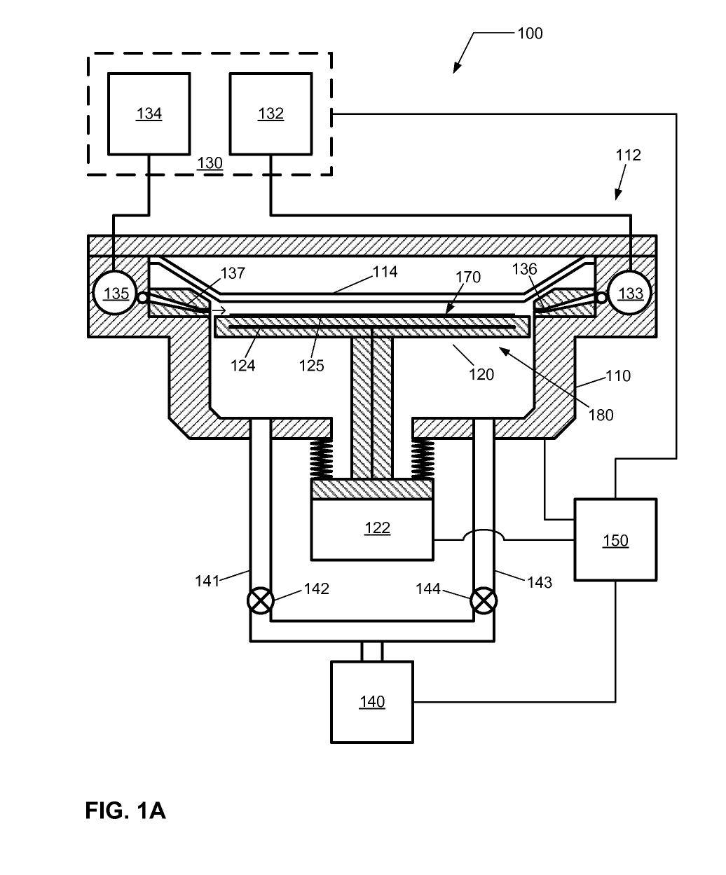

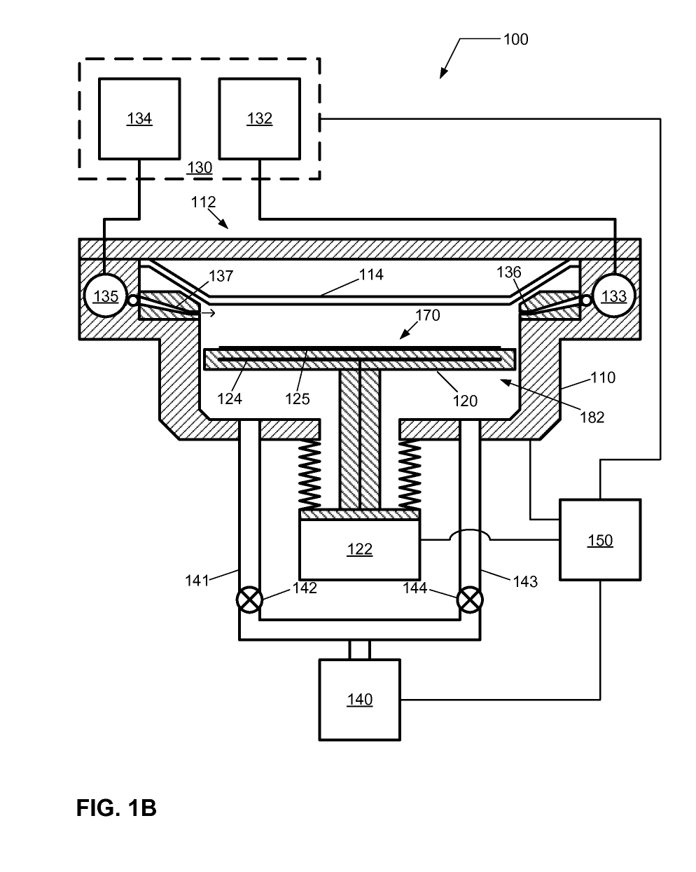

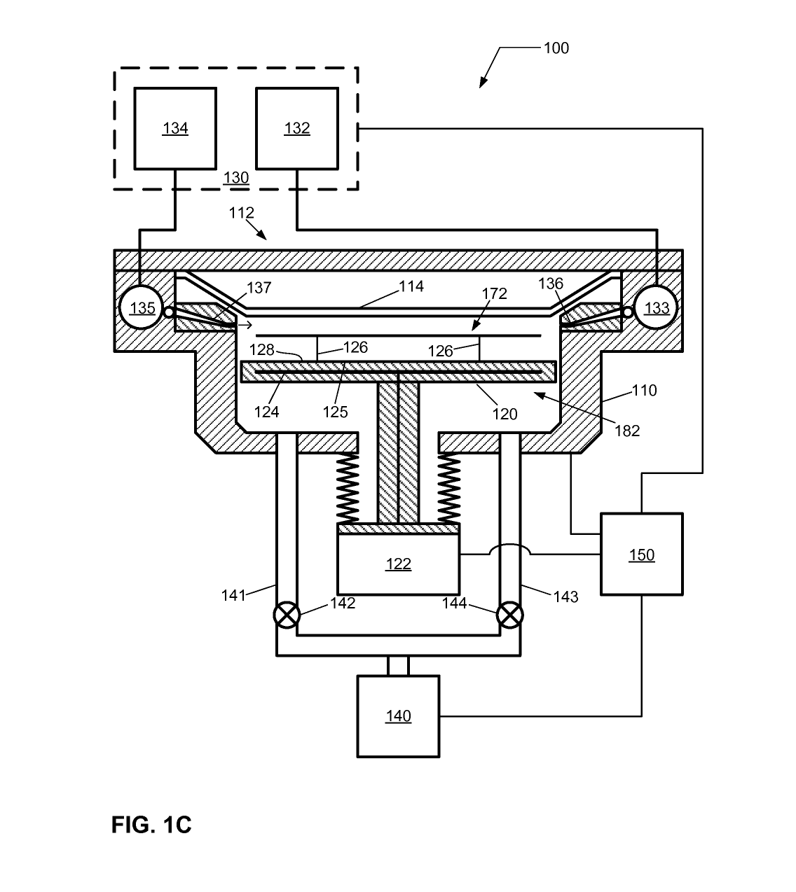

Therefore, referring now to the drawings, wherein like reference numerals designate identical or corresponding parts throughout the several views, FIGS. 1A through 1C depict a substrate processing system 100 according to an embodiment. The substrate processing system 100 may include a deposition system, such as a vapor deposition system. For example, the substrate processing system 100 may include an atomic layer deposition (ALD) system. Alternatively, however, substrate processing system 100 may include a plasma enhanced ALD (PEALD) system, a chemical vapor deposition system (CVD), a plasma enhanced CVD (PECVD) system, a filament assisted CVD (FACVD) system, a physical vapor deposition (PVD) system, an ionized PVD (iPVD) system, an atomic layer epitaxy (ALE) system), a molecular beam epitaxy (MBE) system, etc. Further, although embodiments to follow are described in the context of deposition, these embodiments are applicable to other systems and processes. For example, the substrate processing system 100 may include an etch system, a thermal processing system, a rapid thermal processing (RTP) system, an annealing system, a rapid thermal annealing (RTA) system, a furnace, etc.

The substrate processing system 100 may, for example, be used to deposit metal-containing films during the metallization of inter-connect and intra-connect structures for semiconductor devices in back-end-of-line (BEOL) operations. Alternatively, the substrate processing system 100 may, for example, be used to deposit metal-containing films during the fabrication of gate dielectrics and/or gate electrodes in front-end-of-line (FEOL) operations.

Substrate processing system 100, configured, for example, to facilitate a deposition process, comprises a process chamber 110 having a substrate holder 120 configured to support a substrate 125, upon which a thin film may be formed, etched, or treated. The process chamber 110 further comprises an upper assembly 112 through which a process material and/or a cleaning material may be introduced to the process chamber 110 from a material delivery system 130. Additionally, substrate processing system 100 comprises a vacuum pumping system 140 coupled to the process chamber 110 and configured to evacuate process chamber 110 through one or more pumping ducts 141, 143. Furthermore, substrate processing system 100 comprises a controller 150 that can be coupled to process chamber 110, substrate holder 120, material delivery system 130, and vacuum pumping system 140.

The substrate processing system 100 may be characterized as a cross flow processing system, wherein process material and/or cleaning material may be introduced through upper assembly 120 to the substrate processing system 100 in a manner that produces a substantially parallel process gas flow over substrate 125. For example, process material and/or cleaning material may enter from a first side of the substrate processing system 100 and flow over substrate 125 in a direction substantially parallel with substrate 125 to a second side of the substrate processing system 100 that is opposite or diametrically opposite the first side.

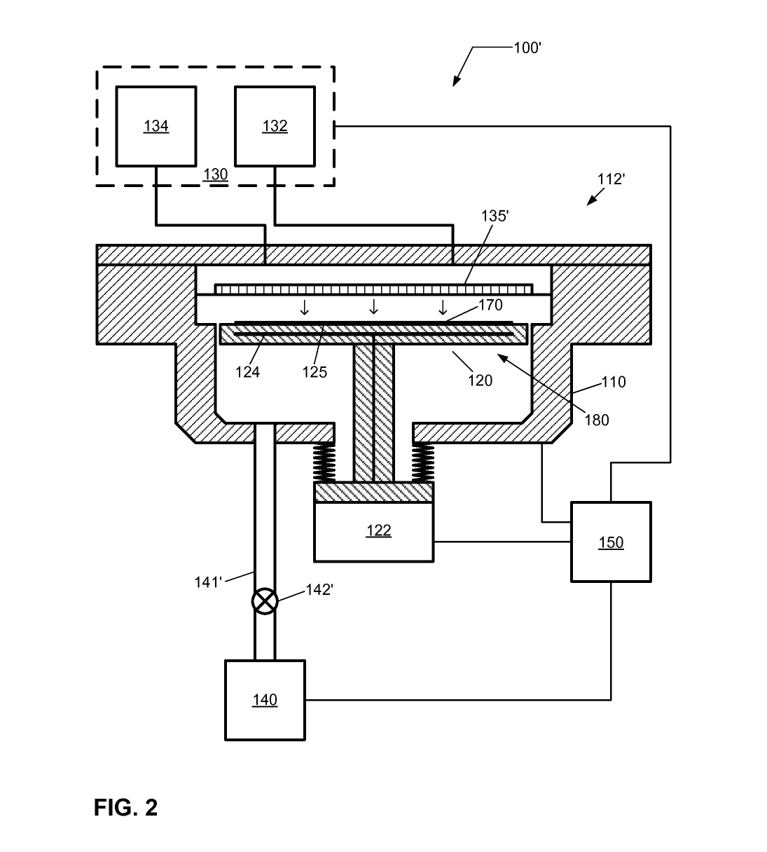

Alternatively, however, as illustrated in FIG. 2 for substrate processing system 100′, the substrate processing system 100′ may be characterized as a stagnation flow processing system, wherein process material and/or cleaning material may be introduced through upper assembly 112′ above substrate 125 in a direction substantially perpendicular to substrate 125 or substrate holder 120. For example, process material and/or cleaning material may enter above substrate 125 through a gas distribution showerhead arrangement 135′ and flow to substrate 125 in a direction substantially perpendicular with substrate 125 or substrate holder 120.

Although not shown, the process material and the cleaning material may be introduced through the same array of one or more openings in the gas distribution showerhead arrangement 135′, or the process material and the cleaning material may be introduced through different arrays of one or more openings in the gas distribution showerhead arrangement 135′. The gas distribution showerhead arrangement 135′ may include one or more gas plenums configured to supply and distribute process material and/or cleaning material to one or more arrays of openings in the gas distribution showerhead arrangement 135′. For example, a first gas plenum may be configured to receive, supply, and distribute process material and/or a purge gas to a first array of openings in the gas distribution showerhead arrangement 135′, and a second gas plenum, different from the first gas plenum, may be configured to receive, supply, and distribute cleaning material and/or a purge gas to a second array of openings, different from the first array of openings, in the gas distribution showerhead arrangement 135′.

Alternatively yet, the process material and/or cleaning material may be introduced using various techniques, including a combination of cross flow and stagnation flow arrangements.

Additionally, the substrate processing system 100 may be configured to process 200 mm substrates, 300 mm substrates, or larger-sized substrates. In fact, it is contemplated that the substrate processing system 100 may be configured to process substrates, wafers, or LCD (liquid-crystal display) panels regardless of their size, as would be appreciated by those skilled in the art.

Substrates can be introduced to process chamber 110 through a passage (not shown), and they may be lifted to and from an upper surface of substrate holder 120 via a substrate lift system 126. The substrate lift system 126 may, for example, include an array of lift pins that extend through the substrate holder 120 to the backside of substrate 125, thus, enabling vertical translation of substrate 125 between a substrate process position 170 (see FIGS. 1A and 1B) on an upper surface 128 of the substrate holder 120 and a substrate exchange position 172 (see FIG. 1C) located above the upper surface 128 of the substrate holder 120. When processing substrate 125, the substrate holder may be positioned at a process location 180 (see FIG. 1A). Alternatively, when loading or unloading substrate 125, the substrate holder may be positioned at a transfer location 182 (see FIGS. 1B and 1C).

Referring to FIG. 1A, the material delivery system 130 may include a process material supply system 132 for introducing process material to process chamber 110, and a cleaning material supply system 134 for introducing cleaning material to process chamber 110. The process material supply system 132 may be configured to provide a continuous flow, a cyclical flow, or an acyclical flow of process material to process chamber 110. Additionally, the cleaning material supply system 134 may be configured to provide a continuous flow, a cyclical flow, or an acyclical flow of cleaning material to process chamber 110.

The process material can, for example, comprise a film forming composition, such as a composition having the principal atomic or molecular species found in the film formed on substrate 125, or the process material can, for example, comprise an etchant or other treating agent. As shown in FIG. 1A, the process material may be prepared and supplied to the process chamber 110 through the upper assembly 112 using the material delivery system 130. The process material can originate as a solid phase, a liquid phase, or a gaseous phase, and it may be delivered to process chamber 110 in a gaseous phase with or without the use of an additive gas and/or a carrier gas.

For example, the process material may include one or more gases, or one or more vapors formed in one or more gases, or a mixture of two or more thereof. The process material supply system 132 can include one or more gas sources, or one or more vaporization sources, or a combination thereof. Herein vaporization refers to the transformation of a material (normally stored in a state other than a gaseous state) from a non-gaseous state to a gaseous state. Therefore, the terms “vaporization,” “sublimation” and “evaporation” are used interchangeably herein to refer to the general formation of a vapor (gas) from a solid or liquid material, regardless of whether the transformation is, for example, from solid to liquid to gas, solid to gas, or liquid to gas.

Additionally, the process material may, for example, include a purge gas. The purge gas may comprise an inert gas, such as a Noble gas (i.e., helium, neon, argon, xenon, krypton), or other gas, such as an oxygen-containing gas, a nitrogen-containing gas, and/or a hydrogen-containing gas.

The cleaning material can, for example, comprise ozone. As shown in FIG. 1A, ozone may be created using an ozone gas generator and supplied to the process chamber 110 through the upper assembly 112 (or upper assembly 112′ shown in FIG. 2) using the material delivery system 130. The ozone gas generator may include an H-series, P-series, C-series, or N-series ozone gas generating system commercially available from TMEIC (Toshiba Mitsubishi-Electric Industrial Systems Corporation, Tokyo, Japan). An oxygen-containing gas is supplied to the ozone gas generator, and optionally a nitrogen-containing gas is supplied to act as a catalyst. The oxygen-containing gas may include O₂, NO, NO₂, N₂O, CO, or CO₂, or any combination of two or more thereof. The nitrogen-containing gas may include N₂, NO, NO₂, N₂O, or NH₃, or any combination of two or more thereof. For example, O₂ and, optionally, N₂ may be supplied to the ozone gas generator to form ozone.

Additionally, the cleaning material may, for example, include a purge gas. The purge gas may comprise an inert gas, such as a Noble gas (i.e., helium, neon, argon, xenon, krypton), or other gas, such as an oxygen-containing gas, a nitrogen-containing gas, and/or hydrogen-containing gas.

Referring still to FIG. 1A, the upper assembly 112 comprises two or more nozzle assemblies disposed on opposing sides of process chamber 110. A first nozzle assembly, disposed on a first side of process chamber 110, comprises a first nozzle plenum 133 coupled to the process material supply system 132 and configured to receive a flow of process material, or purge gas, or a combination thereof. The first nozzle plenum 133 feeds a first nozzle array 136, which injects the flow of process material, or purge gas, or combination thereof into process chamber 110 in a manner that produces a substantially parallel gas flow over substrate 125. The first nozzle array 136 comprises one or more nozzles, which coalesce to form a substantially uniform gas flow across substrate 125.

A second nozzle assembly, disposed on a second side of process chamber 110, comprises a second nozzle plenum 135 coupled to the cleaning material supply system 134 and configured to receive a flow of cleaning material, or purge gas, or a combination thereof. The second nozzle plenum 135 feeds a second nozzle array 137, which injects the flow of cleaning material, or purge gas, or combination thereof into process chamber 110 in a manner that produces a substantially parallel gas flow over substrate 125. The second nozzle array 137 comprises one or more nozzles, which coalesce to form a substantially uniform gas flow across substrate 125.

The first and second nozzle plenums 133, 135 may include cylindrical or rectangular volumes having a length greater than or equal to the diameter or width of substrate 125. Each nozzle plenum 133, 135 feeds the one or more nozzles in each of the first and second nozzle arrays 136, 137. The one or more nozzles in each array may be equally or unequally spaced along the length of each nozzle plenum 133, 135.

As illustrated in FIG. 1A, the upper assembly 112 may further include a flow conditioning member 114 that assists a stable coalescence of the nozzle streams to form a substantially uniform, stable flow across substrate 125. Moreover, the flow conditioning member 114 facilitates a reduction in the process space residing above substrate 125 in process chamber 110.

The material delivery system 130 can include one or more material sources, one or more pressure control devices, one or more flow control devices, one or more filters, one or more valves, or one or more flow sensors. For example, the material delivery system 130 may be configured to alternatingly introduce one or more process materials, one or more cleaning materials, or one or more purge gases, or any combination of two or more thereof to process chamber 110. Furthermore, the material delivery system 130 may be configured to alternatingly introduce one or more process materials, one or more cleaning materials, or one or more purge gases, or any combination of two or more thereof through the first nozzle assembly, or the second nozzle assembly, or both the first and second nozzle assemblies to the process chamber 110.

Referring still to FIG. 1A, the substrate holder 120 comprises one or more temperature control elements 124 that may be configured for heating, or cooling, or both heating and cooling. Further, the one or more temperature control elements 124 may be arranged in more than one separately controlled temperature zones. The substrate holder 120 may have two thermal zones, including an inner zone and an outer zone. The temperatures of the zones may be controlled by heating or cooling the substrate holder thermal zones separately.

According to one example, the one or more temperature control elements 124 may include a substrate heating element embedded beneath the surface of or within the substrate holder 120. For instance, substrate heating element may include a resistive heating element. Alternatively, for instance, substrate heating element may include a re-circulating fluid flow that transfers heat from a heat exchanger system to the substrate holder 120.

According to another example, the one or more temperature control elements 124 may include a substrate cooling element embedded beneath the surface of or within the substrate holder 120. For instance, the substrate cooling element may include a re-circulating fluid flow that receives heat from substrate holder 120 and transfers heat to a heat exchanger system. According to yet another example, the one or more temperature control elements 124 may include one or more thermo-electric devices.

Additionally, the substrate holder 120 may optionally comprise a substrate clamping system (e.g., electrical or mechanical clamping system) to clamp the substrate 125 to the upper surface of substrate holder 120. For example, substrate holder 120 may include an electrostatic chuck (ESC).

Furthermore, the substrate holder 120 may optionally facilitate the delivery of heat transfer gas to the back-side of substrate 125 via a backside gas supply system to improve the gas-gap thermal conductance between substrate 125 and substrate holder 120. Such a system can be utilized when temperature control of the substrate is required at elevated or reduced temperatures. For example, the backside gas system can comprise a two-zone gas distribution system, wherein the backside gas (e.g., helium) pressure can be independently varied between the center and the edge of substrate 125.

Although not shown, process chamber 110 may also include one or more temperature control elements that may be configured for heating, or cooling, or both heating and cooling. For example, the one or more temperature control elements may include a wall heating element configured to elevate the temperature of the process chamber 110 in order to reduce condensation, which may or may not cause film formation on surfaces of the process chamber 110, and the accumulation of residue. Furthermore, the upper assembly 112 of process chamber 110 may also include one or more temperature control elements that may be configured for heating, or cooling, or both heating and cooling. For example, the one or more temperature control elements may include a gas/vapor delivery heating element configured to elevate the temperature of the surfaces in contact with process material, cleaning material, or purge gases, or a combination thereof introduced to process chamber 110.

Acting on program instructions, a temperature control system, or controller 150, or both may be configured to monitor, adjust, and/or control the temperature of substrate holder 120. For example, the substrate holder 120 may be operated at a temperature ranging up to approximately 600 degrees C. Alternatively, for example, the substrate holder 120 may be operated at a temperature ranging up to approximately 500 degrees C. Alternatively, for example, the substrate holder 120 may be operated at a temperature ranging from approximately 200 degrees C. to approximately 400 degrees C.

Additionally, also acting on program instructions, a temperature control system, or controller 150, or both may be configured to monitor, adjust, and/or control the temperature of process chamber 110. For example, the process chamber 110 may be operated at a temperature ranging up to approximately 400 degrees C. Alternatively, for example, the process chamber 110 may be operated at a temperature ranging up to approximately 300 degrees C. Alternatively, for example, the process chamber 110 may be operated at a temperature ranging from approximately 50 degrees C. to approximately 200 degrees C.

The temperature control system, or controller 150, or both may use one or more temperature measuring devices to monitor one or more temperatures, such as a temperature of substrate 125, a temperature of substrate holder 120, a temperature of process chamber 110, etc.

As an example, the temperature measuring device may include an optical fiber thermometer, an optical pyrometer, a band-edge temperature measurement system as described in pending U.S. patent application Ser. No. 10/168,544, filed on Jul. 2, 2002 and now issued as U.S. Pat. No. 6,891,124, the contents of which are incorporated herein by reference in their entirety, or a thermocouple such as a K-type thermocouple. Examples of optical thermometers include: an optical fiber thermometer commercially available from Advanced Energies, Inc., Model No. OR2000F; an optical fiber thermometer commercially available from Luxtron Corporation, Model No. M600; or an optical fiber thermometer commercially available from Takaoka Electric Mfg., Model No. FT-1420.

Referring still to FIG. 1A, the vacuum pumping system 140 may include a dry vacuum pump, such as a turbo-molecular vacuum pump (TMP) or a cryogenic pump capable of a pumping speed up to about 5000 liters per second (and greater), coupled to process chamber 110 and configured to evacuate process chamber 110 through one or more pumping ducts 141, 143. The vacuum pumping system 140 may comprise one or more vacuum valves 142, 144 to control the pumping speed delivered to process chamber 110. Furthermore, the vacuum pumping system 140 may comprise a pressure control system for monitoring, adjusting, and/or controlling the pressure in process chamber 110.

Pumping ducts 141, 143 with vacuum valves 142, 144 may be disposed on opposing sides of process chamber 110. For example, the location of the pumping ducts 141, 143 may correspond to the location of the first and second nozzle arrays 136, 137. The vacuum valves 142, 144 may be operated in a synchronous manner or an asynchronous manner. For example, vacuum valves 142, 144 may be alternatingly and sequentially operated such that at any given time only one of the vacuum valves 142, 144 is open.

Alternatively, as shown in FIG. 2, the vacuum pumping system 140 may be coupled to the process chamber 110 using a pumping duct 141′ and at least one vacuum valve 142′.

Referring again to FIG. 1A, controller 150 can comprise a microprocessor, memory, and a digital I/O port capable of generating control voltages sufficient to communicate and activate inputs to substrate processing system 100 as well as monitor outputs from substrate processing system 100. Moreover, the controller 150 may be coupled to and may exchange information with the process chamber 110, substrate holder 120, material delivery system 130, and vacuum pumping system 140. For example, a program stored in the memory may be utilized to activate the inputs to the aforementioned components of the substrate processing system 100 according to a process recipe in order to perform a deposition process, an etching process, a treatment process, and/or a cleaning process.

However, controller 150 may be configured for any number of processing elements (110, 120, 130, 140), and the controller 150 can collect, provide, process, store, and display data from processing elements. Controller 150 can comprise a number of applications for controlling one or more of the processing elements. For example, controller 150 may include a graphic user interface (GUI) component (not shown) that can provide easy to use interfaces that enable a user to monitor and/or control one or more processing elements.

Alternately, or in addition, controller 150 may be coupled to one or more additional controllers/computers (not shown), and controller 150 may obtain setup and/or configuration information from an additional controller/computer.

Controller 150 or portions of controller 150 may be locally located relative to the substrate processing system 100 and/or may be remotely located relative to the substrate processing system 100. For example, the controller 150 may exchange data with the substrate processing system 100 using at least one of a direct connection, an intranet, the Internet and a wireless connection. The controller 150 may be coupled to an intranet at, for example, a customer site (i.e., a device maker, etc.), or it may be coupled to an intranet at, for example, a vendor site (i.e., an equipment manufacturer). Additionally, for example, the controller 150 may be coupled to the Internet. Furthermore, another computer (i.e., controller, server, etc.) may access, for example, the controller 150 to exchange data via at least one of a direct connection, an intranet, and the Internet. As also would be appreciated by those skilled in the art, the controller 150 may exchange data with the substrate processing system 100 via a wireless connection.

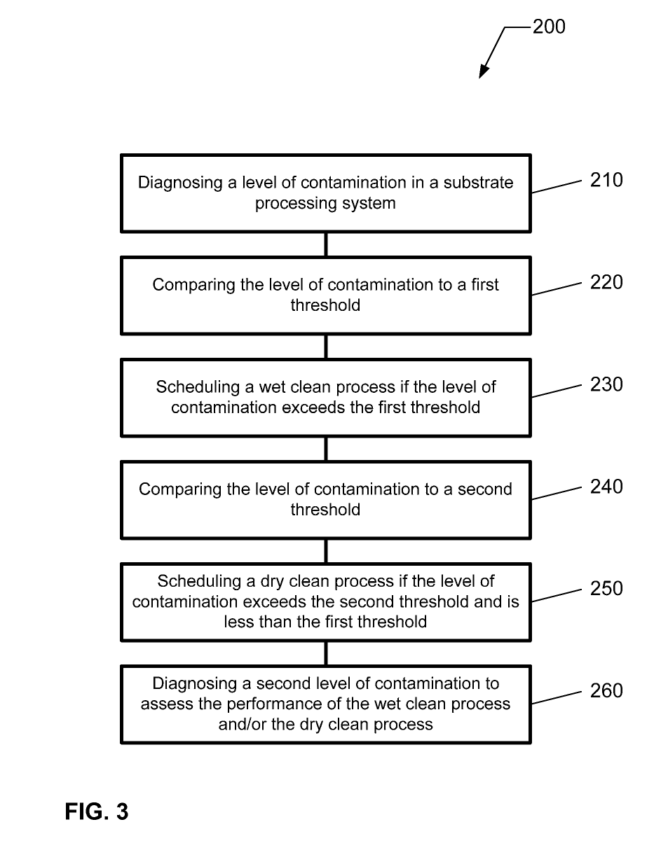

Referring now to FIG. 3, a method of performing preventative maintenance in a substrate processing system is described according to an embodiment. The substrate processing system may, for example, include substrate processing system 100 described in FIGS. 1A through 1C, or substrate processing system 100′ described in FIG. 2. Additionally, the substrate processing system may, for example, include a deposition system, an etching system, or any of the aforementioned processing systems. The method comprises a flow chart 200 beginning in 210 with diagnosing a level of contamination in a substrate processing system. The contamination may include metal contamination formed in the substrate processing system in a deposition process or an etching process, for example.

The diagnosis of the level of contamination in the substrate processing system may be performed in-situ or ex-situ. The diagnosis may include visual inspection of one or more interior surfaces of the process chamber including, for example, a chamber wall, substrate holder, a substrate, etc. Alternatively, the diagnosis may include analytic inspection of one or more interior surfaces/volumes of the process chamber including, for example, an exposed surface of a chamber wall, a substrate holder, a substrate, etc. Analytic inspection for assessing levels of contamination, such as metal contamination, may include vapor phase decomposition-atomic absorption spectrophotometry (VPD-AAS), VPD-inductively coupled plasma-mass spectrometry (VPD-ICP-MS), or total-reflection X-ray fluorescence spectrometry (TXRF).

In 220, the level of contamination is compared to a first threshold.

In 230, a wet clean process is scheduled if the level of contamination exceeds the first threshold. The wet clean process is performed by venting the process chamber from vacuum to atmospheric pressure, and breaking the vacuum seal of the process chamber. Residue in the process chamber is removed by manually wiping down the interior surfaces of the process chamber. Additionally, chamber components may be removed, cleaned, and replaced. Unfortunately, the wet clean process is a time consuming process which lowers utilization of the substrate processing system, not only by the time required to wet clean the process chamber, but also by the time required to re-stabilize the substrate processing system for processing.

In 240, the level of contamination is compared to a second threshold.

The first and second thresholds for determining whether to perform a dry clean process or a wet clean process may be operator-specific, customer-specific, device-specific, structure-specific, process-specific, contaminant-specific, etc. For example, the second threshold may be set at a value of approximately 5×10¹⁰ metal atoms/cm². The first threshold may be set at a value greater than the second threshold. Alternatively or cumulatively, the first threshold may relate to a frequency of occurrences that the level of metal contamination exceeds the second threshold, or a time between occurrences that the level of metal contamination exceeds the second threshold, for instance.

In 250, a dry clean process is scheduled if the level of contamination exceeds the second threshold and is less than the first threshold. The dry clean process is performed using ozone produced by an ozone generator coupled to the substrate processing system.

In 260, a second level of contamination is diagnosed to assess the performance of the wet clean process (in 230) and/or the dry clean process (in 250). If the performance of the wet clean process and/or the dry clean process is/are unacceptable, then another wet clean process and/or dry clean process may be scheduled. The assessment of the performance of the respective cleaning process may utilize the same first and second threshold values for contamination level discussed above, or they may be different.

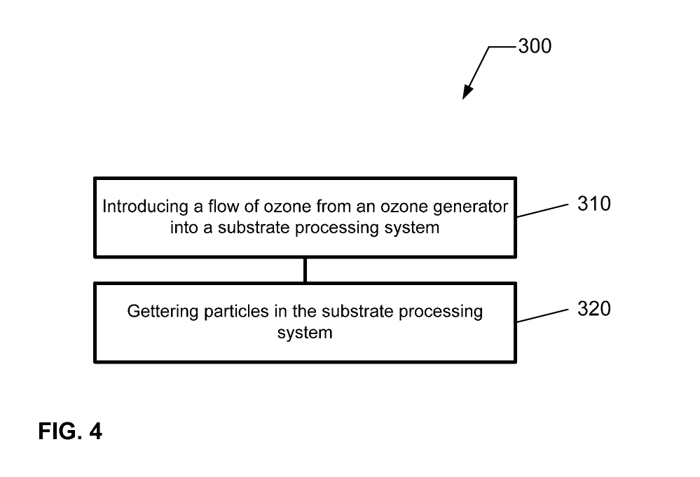

As shown in FIG. 4, a method of performing a dry clean process is described according to another embodiment. The method comprises a flow chart 300 beginning in 310 with introducing a flow of ozone into the substrate processing system.

In 320, material is gettered in the substrate processing system. The gettering of material may include gettering atoms, molecules, particles, etc.

The gettering of material in the substrate processing system comprises disposing a substrate on an exposed surface of a substrate holder in the substrate processing system, and vertically translating the substrate, disposed within the substrate processing system, between the exposed surface of the substrate holder and a plane located above the exposed surface of the substrate holder. For example, the exposed surface of the substrate holder may include an upper surface of the substrate holder, wherein a substrate disposed onto the substrate holder is vertically translated between the upper surface of the substrate holder (e.g., a substrate process location) and a substrate load/unload plane (e.g., substrate exchange position) using a substrate lift system (e.g., substrate lift pins). The vertical translation of the substrate to and from the upper surface of the substrate holder facilitates gettering of material in the substrate processing system.

The vertical translating of the substrate may comprise cycling the substrate up and down for approximately 1 to approximately 100 cycles. Alternatively, the vertical translating of the substrate may comprise cycling the substrate up and down for approximately 10 to approximately 30 cycles.

The flow of ozone may be introduced to the substrate processing system parallel to the exposed surface of the substrate holder. Alternatively, the flow of ozone may be introduced to the substrate processing system perpendicular to the exposed surface of the substrate holder. Additionally, the flow of ozone may be introduced to the substrate processing system when the substrate is located at the plane located above the exposed surface of substrate holder (e.g., the substrate exchange position). Alternatively, the flow of ozone may be introduced to the substrate processing system when the substrate is located at the exposed surface or upper surface of the substrate holder (e.g., the substrate process position). As described above, the ozone may be produced by supplying an oxygen-containing gas and, optionally, a nitrogen-containing gas to an ozone generator. For instance, the ozone may be produced using one or more gases selected from the group consisting of O₂, N₂, NO, NO₂, and N₂O.

The pressure in the substrate processing system may be established by coupling a vacuum pumping system to the substrate processing system, and controlling the pressure by adjusting the pumping speed delivered to the substrate processing system by the vacuum pumping system. The required pumping speed to achieve a specific pressure depends on the vacuum design (i.e., flow conductance) of the substrate processing system and the total flow rate of gases into the substrate processing system. As described above, the vacuum pumping system may be coupled to the substrate processing system at one or more locations in the substrate processing system. When two or more locations for pumping are utilized, the two or more locations may be located on opposing sides of the substrate processing system. Furthermore, the evacuation of the substrate processing system through the two or more locations may be cyclically alternated between the two or more locations.

The dry clean process may further comprise: controlling a temperature of the substrate, the substrate holder, the process chamber, or the upper assembly of the process chamber, or any combination of two or more thereof. For example, the temperature of the substrate holder may be elevated.

The dry clean process may comprise one or more cleaning steps, wherein each cleaning step may include a process parameter space as follows: a chamber pressure ranging up to about 1000 mtorr (millitorr), an O₂ process gas flow rate (into the ozone generator) ranging up to about 2000 sccm (standard cubic centimeters per minute) (e.g., about 1000 sccm), an optional N₂ process gas flow rate (into the ozone generator) ranging up to about 10 sccm (e.g., about 0.1 sccm), a purge gas (e.g., Ar) flow rate (into the process chamber) ranging up to about 2000 sccm (e.g., about 500 sccm), and a substrate holder temperature ranging up to 600 degrees C. (e.g., 300 degrees C.). Cycling the vertical translation of the substrate may proceed for up to about 100 cycles (e.g., 10 to 30 cycles). Furthermore, cycling the opening and closing of two valves in the vacuum pumping system corresponding to two opposing pumping ducts coupled to the process chamber may be synchronized with the cycling of the substrate.

As an example, Table 1 presents the process parameter settings for a dry clean process. The dry clean process comprises three (3) dry clean process steps for cleaning the interior of the substrate processing system described in FIGS. 1A through 1C, wherein the second and third process steps are cycled for the prescribed number of cycles. The substrate processing system may include a deposition system for depositing metal-containing film. The substrate holder is positioned in the transfer position (i.e., the transfer position 182 in FIG. 1B) and the temperature of the substrate holder is set to 305 degrees C.

A substrate disposed on substrate holder initially rests on the substrate holder (i.e., the substrate process position 170 in FIGS. 1A and 1B) during the first process step. Then, in process steps 2 and 3, the substrate cycles through vertical translations up and down between two positions (i.e., the substrate process position 170 in FIGS. 1A and 1B, and the substrate exchange position in FIG. 1C), while the substrate holder remains in the transfer position.

Ozone is introduced from the left side of the process chamber (i.e., the second nozzle array 137 in FIGS. 1A through 1C) using O₂ and N₂ to produce ozone in the ozone generator. Argon (Ar) is introduced from the right side of the process chamber (i.e., the first nozzle array 136 in FIGS. 1A through 1C). Further, the vacuum valves corresponding to the two pumping ducts accessing the left side and right side of the process chamber (i.e., valves 142, 144 in FIGS. 1A through 1C) open and close accordingly.

Using the above identified conditions for cleaning the deposition system utilized for forming metal-containing films, such as Hf-containing films, the inventors have observed that metal contamination may be maintained at levels less than 5×10¹⁰ metal atoms/cm².

TABLE 1

| | Substrate holder | | Ozone generator | | | | | | | |
|---|---|---|---|---|---|---|---|---|---|---|
| Dry clean | Temperature | | O2 flow rate | N2 flow rate | Ar flow | Vacuum pumping system | | Substrate | Time | No. of |
| process steps | (deg. C) | Position | (sccm) | (sccm) | rate | Valve (Left) | Valve (Right) | Position | (sec) | cycles |
| 1 | 305 | Transfer | 1000 | 0.1 | 500 | Open | Close | Process | 15 | 0 |
| 2 | 305 | Transfer | 1000 | 0.1 | 500 | Open | Close | Process | 5 | 20 |
| 3 | 305 | Transfer | 1000 | 0.1 | 500 | Close | Open | Exchange | 5 | 20 |

Although only certain embodiments of this invention have been described in detail above, those skilled in the art will readily appreciate that many modifications are possible in the embodiments without materially departing from the novel teachings and advantages of this invention. Accordingly, all such modifications are intended to be included within the scope of this invention.

1. A method of performing preventative maintenance in a substrate processing system, comprising:
diagnosing a level of contamination in a substrate processing system;
comparing said level of contamination to a first threshold;
scheduling a wet clean process if said level of contamination exceeds said first threshold;
comparing said level of contamination to a second threshold; and
scheduling a dry clean process if said level of contamination exceeds said second threshold and is less than said first threshold,
wherein said dry clean process is performed by introducing a flow of ozone produced by an ozone generator coupled to said substrate processing system and gettering material in said substrate processing system.

2. The method of claim 1, further comprising:
diagnosing a second level of contamination in said substrate processing system to assess a performance of said wet clean process, or said dry clean process, or both said wet clean process and said dry clean process.

3. The method of claim 2, wherein said gettering material comprises:
disposing a substrate on an exposed surface of a substrate holder in said substrate processing system; and
vertically translating said substrate between said exposed surface of said substrate holder and a plane located above said exposed surface of said substrate holder.

4. The method of claim 3, wherein said vertically translating comprises cycling said substrate up and down for 1 to 100 cycles.

5. The method of claim 3, wherein said vertically translating comprises cycling said substrate up and down for 10 to 30 cycles.

6. The method of claim 3, wherein said flow of ozone is introduced to said substrate processing system parallel to said exposed surface of said substrate holder, or perpendicular to said exposed surface of said substrate holder, or both.

7. The method of claim 6, wherein said flow of ozone is introduced to said substrate processing system when said substrate is at said plane located above said exposed surface of said substrate holder.

8. The method of claim 1, further comprising:
introducing a flow of an inert gas into said substrate processing system during said dry clean process.

9. The method of claim 1, wherein said ozone is produced by introducing an oxygen-containing gas and a nitrogen-containing gas to said ozone generator.

10. The method of claim 1, wherein said ozone is produced by introducing one or more gases selected from the group consisting of O₂, N₂, NO, NO₂, and N₂O to said ozone generator.

11. The method of claim 1, further comprising:
evacuating said substrate processing system at one or more locations in said substrate processing system.

12. The method of claim 1, wherein said contamination comprises metal contamination.

13. The method of claim 1, further comprising:
alternatingly and sequentially introducing said flow of ozone with a flow of purge gas.

14. A dry cleaning method for removing particle contamination from a deposition system, said method comprising:
disposing a substrate on an upper surface of a substrate holder in a deposition system;
introducing a flow of ozone from an ozone generator into said deposition system; and
gettering material in said deposition system using said substrate.

15. The method of claim 14, wherein said gettering material comprises vertically translating said substrate between said upper surface of said substrate holder and a plane located above said upper surface of said substrate holder.

16. The method of claim 15, wherein said vertically translating comprises cycling said substrate up and down for 10 to 30 cycles.

17. The method of claim 15, wherein said flow of ozone is introduced to said deposition system parallel to said upper surface of said substrate holder or perpendicular to said upper surface of said substrate holder.

18. The method of claim 17, wherein said flow of ozone is introduced to said deposition system when said substrate is at said plane located above said upper surface of said substrate holder.

19. The method of claim 14, wherein said ozone is produced by introducing an oxygen-containing gas and a nitrogen-containing gas to said ozone generator.

20. The method of claim 14, further comprising:
alternatingly and sequentially introducing said flow of ozone with a flow of purge gas.
